(19) United States
(12) Patent Application Publication
(10) Pub. No.: US 2020/0104960 A1
(43) Pub. Date: Apr. 2, 2020

(54) Student Learning Guidance Platform- eGPS

(71) Applicant: Fuliang Weng, Mountain View, CA (US)

(72) Inventor: Fuliang Weng, Mountain View, CA (US)

(21) Appl. No.: 16/590,372

(22) Filed: Oct. 1, 2019

Related U.S. Application Data
(60) Provisional application No. 62/740,203, filed on Oct. 2, 2018.

(51) Int. Cl. G06Q 50/20; G09B 7/00

(52) U.S. Cl. CPC G06Q 50/205; G09B 7/00

(57) ABSTRACT

A student learning guidance platform that includes a functional module for understanding a problem and formulating solutions for the given problem thus formulating and providing possible paths from the given problem to the solutions; a functional module for monitoring how a student solves the problem when the student processes from a first state to a succeeding state in a problem space; a functional module for figuring out whether there is a gap between the student and a required and finding a reason why; a functional module for providing assistance where necessary and further providing a process for a competent teacher to participate assistance when necessary; and a functional module for building a student model and recommending necessary steps for the student to improve.

### CROSS REFERENCE TO RELATED APPLICATIONS

This Application is a Non-provisional Application and claims the Priority Date of a previously filed Provisional Application 62/740,203 filed on Oct. 2, 2018 by the Applicant of this application. The disclosures made in Application 62/740,203 are hereby incorporated herein by reference.

### FIELD OF THE INVENTION

The present application relates generally to an improved data processing apparatus and method and more specifically to mechanisms for enhanced learning system to provide and manage processes that can assist and guide students to learn and gain knowledge and competence in different subject matters particularly scientific subjects.

### BACKGROUND OF THE INVENTION

With the increased usage of computing networks, e.g., the Internet, and also with the tremendous increase in the processing power and speed of the computer processors, great potential now exists in providing enhanced learning guidance platform to guide and assist students to have improved learning processes.

Implementations of the artificial intelligence (AI) to the learning systems are still quite limited as of now. Therefore, a need still exists to provide new and improve system to overcome such current limitations.

### SUMMARY OF THE INVENTION

One of the prospects of this invention is to provide a student learning system that assists the students to learn a scientific subject or engineering knowledge generally referred herein as eGPS as it functions like a GPS to guide the students to acquire necessary knowledge and competence in a scientific subject.

### BRIEF DESCRIPTION OF THE DRAWINGS

FIG. 1 illustrates an overall architecture of a student learning guidance platform of this invention according to an exemplary embodiments.

FIG. 2 illustrates how the learning guidance system works including the information flow in the eGPS system with competence core assistant and student engagement.

FIG. 3 is a diagram to illustrate the process flow of the learning guidance platform to guide and assist the student to understand and solve the individual problem presented to the students.

### DETAILED DESCRIPTION OF THE INVENTION

Specifically, the eGPS system of this invention performs the following functional processes:
1. Understand any solution steps or related questions provided by the students, engage the students during the problem solving, and provide assistance where necessary.
2. Monitor how the student solves the problem, i.e., how s/he moves from one state to another in the problem space, and figure out whether there is any gap between student and the required, provide guidance step(s) back to a feasible path if there is a significant deviation by the student, and find why based on past experience (student model). This will also include a student model construction and recommend necessary steps for the student to improve in terms of domain knowledge, skill, and competence.
3. Understand any given problem in a given domain, and formulate solutions in a proper way—the paths from the problem initial state to its solutions, which may be provided by a subject teacher.
4. Contribute to the assistance whenever necessary by a 3^{rd} party, such as competent teacher or even a competent peer. This is to address the cold-start issue as well as enrichment of the knowledge and competency of the eGPS system

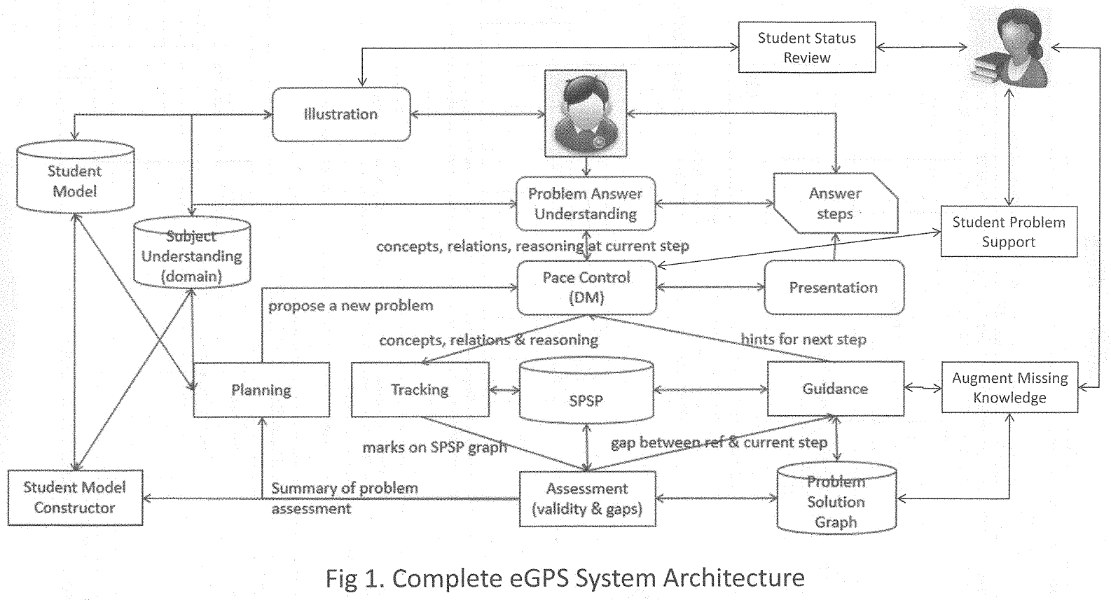

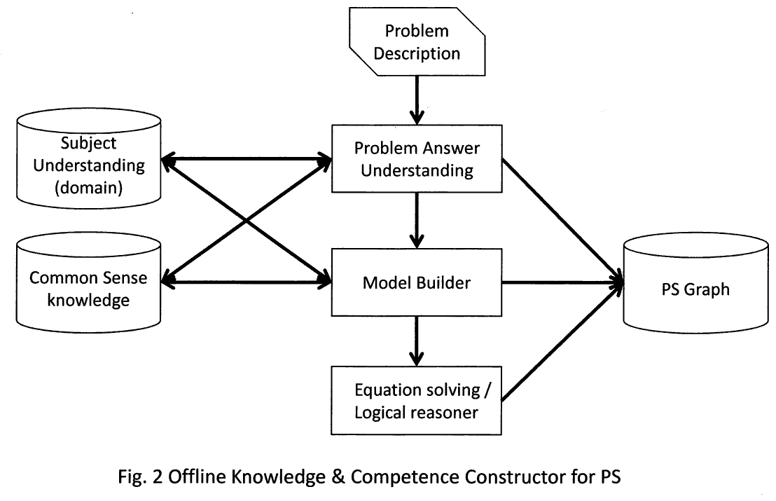

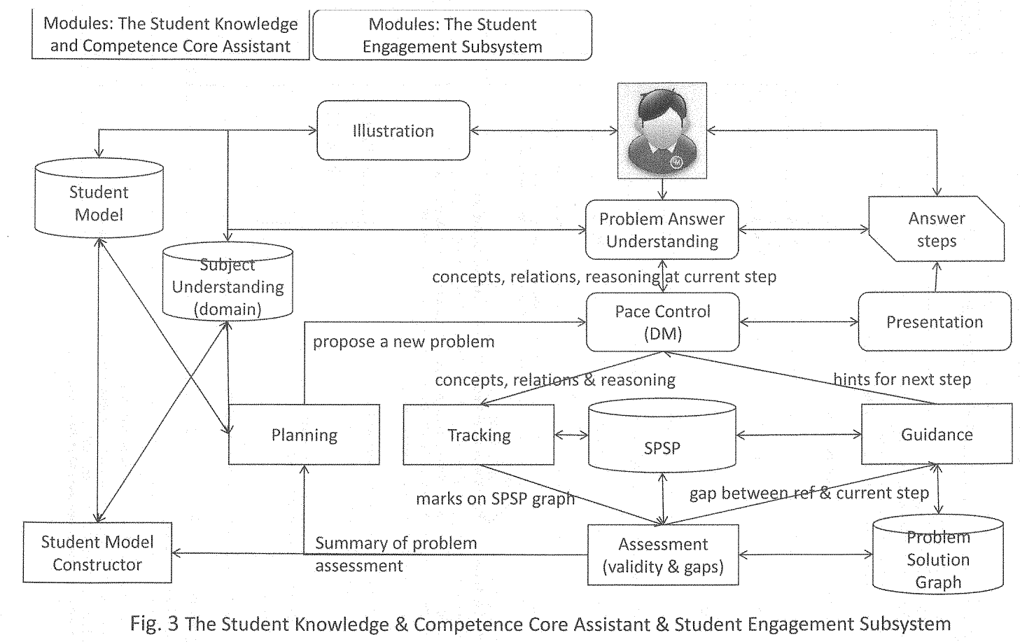

FIG. 1 shows an overall architectural configuration to provide a description of how the system is structured, followed by descriptions in section 2 as illustrated in FIG. 2, that describes how the learning guidance system works including the information flow in the eGPS system with competence core assistant and student engagement followed by the process flows to solve an individual problem as that illustrated in FIG. 3.

### 1. The Overall Architecture

The overall architecture of the system contains a set of four main building blocks: the student engagement subsystem, the student knowledge and competence core assistant subsystem, the 3^{rd} party Assistance Subsystem, and the offline domain knowledge and competence converter subsystem. We will first describe the knowledge bases required to define the problem and solution space for any subject to learn as well as the ones required by the system in section 2.1 as it is needed across all the four building blocks/subsystems. The details of the four subsystems and the functionality of their major modules will be given in section 2.2.

### 2.1The Knowledge Bases

The knowledge bases for a subject describes all the important concepts in the subject area as well as competence skills, including mathematical (what are formal representations, axioms, legitimate deductive steps) and logical foundation (from A to B, and why and how to build a bridge from A to B), as well as common sense assumptions. For the teaching purpose, we also need to characterize what the students have learned and how that are reflected in solving individual problems.

Domain knowledge description. A few key dimensions of the domain knowledge need to be included. They are described as follows:
Prerequisites: what are the prior knowledge and skills required in order to learn the subject effectively
What: the scope of the content and competence to be learned from the subject
Why: why one needs to learn this subject, what kind of problems it intends to solve, and what could be possible applications
How: what kinds of methodology are typically used in the field and are expected to be learned

The goal for the students is to learn the set of necessary concepts and approaches defined in the domain knowledge graph and competence graph. A subset of concepts can be used to indicate which level a student has reached.

There are four important parts reflected in the following four data structures: Subject Understanding (SU) graph, Problem Solving (PS) graph, Student Problem Solving Progress (SPSP) graph, and student model (SM). In the description below, we will provide some details about how the knowledge bases and modules related to student learning.

### 2.1.1 The Domain Knowledge Graphs (SU and PS)

### Subject Understanding (SU) Graph

It indicates different understanding levels of the subject or domain. It uses key concepts in the subject to be learned and their dependencies as the indication for the subject levels. There is only one SU graph template for each subject. Each state in the graph consists of a subset of concepts and relevant skills to these concepts. All the students share the same SU graph template at the initial state. The template will then be instantiated by each student through their problem solving practice, particularly many pairs of problems (or questions) and answers they have gone through. A student or teacher may indicate to the system his or her understanding level of the subject by directly inputting a list of well-understood concepts by them.

In addition to the states for positive concept understanding, one may also include states which indicate clearly certain concepts not understood as well as possible ways to correct the situations. These states may be added by experienced teachers or via data collected from the use of the eGPS system.

A state with all the positive concept understanding may take the form of {A₁, A₂, . . . , Aₖ}, and a state which has incorrectly understood concepts B₁, B₂, . . . , Bᵢ may take the form of {¬B₁, ¬B₂, . . . , ¬Bᵢ} and an union with the remaining correctly understood concept set.

### Problem Solution (PS) Graph

For each problem in a subject, there is a Problem Solution (PS) graph with only one initial node, which is the problem description. Each derived state from the initial state contains a subset of instantiated concepts from the problem description. Instantiated concepts may include examples, such as a distance between two mentioned locations, A and B, or a weight of a specific object mentioned in the problem. A combination of one or more states may lead to a next level state as legalized by a legitimate mathematical equation or a rule in the subject and relevant domains as part of the prerequisite. Examples of such rules may include a rule in physics to describe the relationship among force, mass, and acceleration. A macro rule may contain multiple rules applied in sequence. The PS graph only contains various paths towards the correct solutions. There may be many solutions, therefore, many target nodes. The more details the PS graph becomes, the easier eGPS algorithm will identify the issues a student has.

Problems are categorized into different levels based on the concepts required to solve them. In other words, each problem has links to the SU graph nodes, indicating the level of the subject understanding.

### 2.1.2 The Student Progress Description (SPSP and SM)

This learning progress of a student is specified by two graphs: the Student Problem Solving Progress (SPSP) graph for showing how s/he is solving a particular problem and the

Student model that accumulates the statistics about how well the student commands the subject.

### Student Problem Solving Progress (SPSP) Graph

Problem solving space of a student describes all the progressing states of solving a given problem by the student, and a particular path reflects a particular way a problem is tackled by the student. A state in SPSP is a list of instantiated concepts with links to show the derivations and the justification for the derivations.

The initial node of SPSP graph is the problem description just like PS graph. The outgoing links from the initial node to the next set of nodes in SPSP show the derivation of the concepts the student discovered from the problem description. Additional nodes are introduced when subsequent relationships are found and concepts are built on the previous nodes by the student. A correctly identified relationship needs to be justified by a rule in the subject domain. The introduced nodes and links may not have a correct justification as a student may make mistakes. The Pace Control module described in next section will jump in to interfere when it sees necessary.

The nodes in SPSP do not always match the nodes in PS. Sometimes, a path with multiple nodes and links in the SPSP corresponds to a single transition in the PS graph. This is because it may take multiple steps for the student to recognize the transition. Another times, a single transition in SPSP corresponds to a path with multiple transitions in the PS graph as some students often skip certain steps in problem solving. Even other times, the students may make mistakes and lead to nodes that do not exist in the PS graph. In the latter case, an algorithm identifies the closest matching nodes in the PS, and tries to bring back the student to the correct path. This is similar to the GPS, which tries to guide back the student to the right target. When the close matching nodes are identified, the eGPS system also has the info where the deficits the student has in commanding the subject. Due to the above reasons, some nodes in the SPSP graph are marked as invalid if they don't belong to SP, or unjustified if they are connected by transition links with multiple steps. In addition, each node has a sequence label together with a labelled transition link so to recover the history of the student problem solving process.

A simple eGPS algorithm to bring the student back to the correct path is to find the anchoring node A which is present in both PS and SPSP graphs and its subsequent node D in SPSP does not occur in PS graph. In other words, node D departs from the correct path. The simple algorithm would find the correct subsequent node C in PS with minimum distance with D. C is then communicated to the student so that he/she would use as the next step to node A.

One way to compute the distance between two nodes in their corresponding graphs PS and SPSP is to divide the size of the overlapping instantiated concepts between the two nodes by the size of set union of the concepts from the two nodes. Let A be the set of instantiated concepts of node A in PS, and B be the set of instantiated concepts of node B in SPSP. The distance between node A and B is calculated as:

distance(A, B)=|A∩B |/|A∪B|. (1)

A more elaborated distance may include the distances between the concepts belong to only one of the two graphs, i.e., PS and SPSP, instead of simply using the difference in the overlap between the two sets A and B as in formula (1).

### Student Model

For each student, there is a student model, which reflects which concepts the student has commanded, and which understanding level these concepts correspond to in the Subject Understand (SU) graph.

### 2.2 The Major Building Blocks

This section describes the four major subsystems of eGPS: the student engagement subsystem, the student knowledge and competence core assistant subsystem, the 3^{rd} party Assistance Subsystem, and the offline domain knowledge and competence converter subsystem. The first three blocks and their relationship are included in FIG. 1. The last block is described in FIG. 2.

### 2.2.1 Core Assistant Subsystem

The student knowledge and competence core assistant subsystem includes the following modules.
Tracking module: this module tracks student's answer to the problem at hand step by step, and marks the progress of the problem solving on the SPSP graph.
Assessment module: it assesses the validity of the current answer step by the student based on the PS graph and SPSP graph, and identifies any gap between the current answer step by the student and the nodes of the PS graph for the current problem. It passes the gap info to the guidance module for next steps. During the session for a problem, statistics on concept and reasoning competency gaps is also collected. When a problem is solved/terminated, or a meaningful section of the problem solving is reached (nodes marked on the PS graph), this module provides a summary report of the gap info to the student model constructor and planning module so that they can update the student model and plan the next step, i.e., a new problem for the student to solve.
Guidance module: it guides the student towards a high quality solution to the problem at hand by providing hints and asking for explanations. Such assisting hints may include questioning certain steps the student provides and mentioning concepts the student may miss out at the current step. The requested explanations may include asking for an elaboration of certain details of a specific step and justification why the step is made (based on what domain knowledge or reasoning). It controls the aspects from the system side about what to tell and when to tell during the student is solving a particular problem.
Planning module: it proposes additional steps for the student to enhance knowledge and competence, given the student model and subject understanding graph. For example, one or more new problems to solve. The student may also get a chance to choose which one to do first among the recommended problems by the system.
Student Model Constructor: it updates a student model on the fly while the student is solving a problem in referencing to the SU graph upon the receipt of a summary report from the assessment module. It accumulates statistics about which concepts the student is already very familiar with if s/he constantly makes a correct decision during the problem solving involving these concepts, and which concepts the student is still struggling about if s/he makes wrong decisions while the concepts are involved in the decision points. It also uses the record of the amount of time used to solve various problems and tracks the progress in various aspects of domain concepts and skills over the time.

### Tracking Module

This module tracks student's answer to the problem at hand step by step, and marks the progress of the problem solving on the SPSP graph.

It takes the concepts, direct and derived (via various reasoning) relations obtained from the Pace Control (or Dialogue Manager) Module, creates nodes, and links them to the existing nodes in the SPSP graph (or creates directional edges connecting the existing nodes to the newly created ones). Any concepts directly interpreted from the problem description are connected from the initial node (problem description). They are typically instantiated concepts with another edge linked to the concept nodes in PU, and the instantiation process is completed by the Problem/Answer Understanding module. The relations and derived relations are justified by the mechanism or marked as legal operations in PU graph. Such mechanism can be propositional logic, predicate logic (incl. first order logic, second order logic, etc.), modal logic (to indicate degree of certainty), Horn clause, rules, laws, or theorems established in the domain students are learning. Any concepts and relations are marked as justified, remotely justified, or non-substantiated in SPSP accordingly, where justified means as authorized by the concepts and mechanism in PU graph, remotely justified means valid but without details for a gap in reasoning requiring multiple steps, and non-substantiated refers to the concepts and relations are not present nor reasoned based on the mechanism in the PU graph.

Every time when the student input a step (or a description), a set of concepts and relations are created via the Engagement subsystem and the SPSP is updated via new edges linking the existing concepts and relations to the concepts and relations in the set.

In addition, each step is marked with step id in the SPSP graph so that it can be referenced back when needed.

### Assessment Module

While a student is using the system to solve a problem in a particular domain, a SPSP graph is been constructed as described in the tracking module. The assessment module performs the following functions when a new node is created in the SPSP graph:

1) Assess the validity of the current answer step by the student based on the newly added node(s) in SPSP and their associated nodes in the PS graph. That is, the validity includes
a. Whether the current answer step still matches to any solution path in the PS graph.
b. Whether the current answer step is within the permitted skip step threshold as defined in the PS graph. PS contains solution paths for any problem, and each path contains detailed steps. A skip step threshold k is the number of steps defined so to allow students to legally skip k steps without being considered as an invalid solution.
c. When an answer node in the answer path has more than k skip steps, the answer is considered as incomplete. Depending on the extra skip steps, a partial score is given to the node. One measurement can be the ratio of the number of extra skip steps over the total number of steps to the node in the corresponding (shortest) PS path.

2) If the node in PSPS newly created by the current answer step from the student does not match to any solution path in the PS graph, identify any gap between the current answer step by the student and the nodes of the PS graph for the current problem, based on the result from the Tracking Module.

3) Calculate an accumulated distance between the current answer path in the SPSP and its corresponding path in the PS graph, as built over the steps the student has taken.

4) Pass the gap info to the Guidance module for next steps. During the session for a problem solving, statistics on correct concept understanding and actions taken, as well as concept and reasoning competency gaps is also collected, and accumulated. Examples include how the number of valid nodes in PSPS, the skip steps for each node, the gaps along the solution path provided by the student in referencing to the identified corresponding path in PS graph.

5) When a problem is solved/terminated, or a meaningful section of the problem solving is reached (nodes marked on the PS graph), this module provides a summary report of the gap info to the student model constructor and planning module so that they can update the student model and plan the next step, i.e., a new problem for the student to solve.

The assessment results from this module triggers the system when the guidance module needs to kick in to help the student.

### Guidance Module

The guidance module guides the student towards a high quality solution to the problem at hand by providing hints and asking for explanations when the assessment module detects that the current step, i.e., the newly created node in SPSP graph, is too far away from any sound solution path in the SP graph.

This module essentially controls two aspects from the system side about what to tell and when to tell during the student is solving a particular problem.

For the “what-to-tell” part, two categories of guidance are included in the current guidance module, in addition to a set of more general questions, such as “do you need any help?”. The step under questioning can be the current one or any particular one of the previous steps in the path student generated in SPSP graph. A step node that deviates from the solution path can be under question, and a step node that matches a node in the solution path can also be questioned if it exceeds a preset skip step threshold. Even a valid step matching a node in the solution path can be questioned so that the student knows how to justify a correct answer.

Category 1: request for clarifying or explanation of specific steps the student took during the problem solving. Examples of such questions may include:
1) Do you think this step makes sense? (negative)
2) Why do you take this step? (slightly negative)
3) Can you justify this step? (neutral)
4) Can you elaborate this step? (neutral)

The requested explanations may include asking for an elaboration of certain details of a specific step and justification why the step is made based on what domain knowledge, permissible reasoning skills, and common sense knowledge.

Category 2: questions with hints or suggestive content regarding steps the student took. Examples of such questions may include
1) Can you provide domain rules that lead you from the previous step to the current step? (neutral)
2) Do you see any obvious mistakes in this step? (negative)
3) Can you think of any alternative strategy? (slight negative)
4) Can you think of any better strategy?
5) Why this value goes up after the current step? (pay attention to one outcome)
6) Is this what you wanted?
7) Have you considered strategy X so far?
8) Do you see any applicable cases for theorem Y?
9) Do you see any shorter route around step Z?

In general, assisting hints may include questioning certain steps the student provides with mentioning concepts or strategies the student may have missed out. A specific concept or set of concepts can be mentioned to narrow down the search space the student tried to look for a solution step. This could include conversion of one concept, such as speed, to another, e.g., distance, if a duration is to be identified from the description.

In certain extreme cases when the student is not able to solve the problem at hand, the system will guide step-by-step in bringing the problem solving back to a correct path. The guidance starts from the node in SPSP graph that matches the furthest node along a solution path in the PS graph. Then, follow the solution path in the PS graph, this module guides the student step-by-step to build a path in SPSP graph so to reach the final node of the solution path in the PS graph.

For the when-to-tell part, this guidance module uses the information from the assessment module and a set of pre-set conditions to decide whether the module will start to intervene the problem solving process by the student. Multiple strategies can be deployed and they can be stored in a configuration file.
1) When the assessment module shows that the current solution path by the student deviates beyond a threshold a based on the distance function (1), the guidance module uses category 1 questions.
2) When the deviation exceeds a threshold β, the guidance module uses category 2 questions.
3) When the skipped steps exceed a threshold a, the module may use the neutral type of category 1 questions to ask the student for clarification or explanation.
4) When the student pauses a time beyond a threshold x, the guidance module may issue a general question. Based on the severity degree of the response from the student, the module may provide category 1 or 2 guidance.

In all the above cases, category 1 and 2 questions may be further assigned into sub-categories based on the dependency of concepts and skills as well as the number of concepts and skills involved.

### Planning Module

Planning module proposes additional steps for the student to enhance knowledge and competence, given the student model and subject understanding graph. This module is triggered when the student completes one session of problem solving practice and starts a new session of practice.

The planning module will select one or more problems based on the following aspects:
1) How well certain concepts are understood by the student at the moment (degree)
2) How well certain skills are possessed by the student (degree)
3) The dependency among the concepts

A learning time frame is defined as a fixed number problem solving practices as specified in the subject understanding graph. The numbers of problems needed to be solved for full understanding of a concept or a set of closely related concepts can be a distribution collected from a large data points. One default value for a concept or a set of closely related concepts can be the medium number of such distribution. It can also be provided by a few very experienced teachers explicitly, or implicitly through the use of the 3^{rd} party Assistance Subsystem (defined later).

To better select a problem, problems are organized into problem templates with instantiated parameters. For each parameter in a problem template, a legitimate value range is defined. The value type may be scaler (like real numbers), categorical (like color), Boolean (true or false), or hierarchical (animal categories).

Each problem template is associated with a set of concepts and skills needed to solve it. The dependency relationship among the concepts is defined in the domain knowledge, SU graph. The dependency can be described as a partial order. A problem is a problem template with a set of instantiated parameter values.

Based on the degree of concepts learned and to be learned (student model), the dependency among different concepts, the planning module selects from the problem pool a problem template not presented before with one set of instantiated parameter values, or a problem template presented before but with a different set of parameter values.

When a new problem is selected, the eGPS system will go to a next round of guidance to the student.

### Student Model Constructor

Student Model Constructor updates a student model on the fly while the student is solving a problem in referencing to the SU graph upon the receipt of a summary report from the assessment module.

The student module constructor accumulates statistics about which concepts the student is already very familiar with if s/he constantly makes a correct decision during the problem solving involving these concepts, and which concepts the student is still struggling about if s/he makes wrong decisions while the concepts are involved in the decision points. These statistics come from the assessment module when the student takes steps (nodes) described in SPSP graph compared with a corresponding correct path in the PS graph for any specific problem.

The student module constructor also uses the record of the amount of time used to solve various problems and tracks the progress in various aspects of domain concepts and skills over the time. Consequently, it infers that how well certain concepts and skills in this domain are possessed by the student over the time.

Multiple levels of understanding can be assigned to each concept and skill for a student at a particular time. For example, a five degree of understanding levels can be assigned, similar to the grading system used in the regular teaching practice. If over 90% of the time the student uses and applies a concept in a correct way, A is assigned to the concept in the student model. Subsequently, B, C, D, and F can be assigned if only between 80-89%, 70-79%, 60-69%, and below 60% of the time the student did it correctly within a specified amount of time.

2.2.2 The Student Engagement Subsystem

This subsystem includes the following modules related to student interaction with the eGPS system. We also intends to gamificate this module so that the student may find more interesting to learn the subject.
Problem Answer Understanding module: this module is to understand each step of the problem solution provided by any student. For the initial stage, we intend to provide the students to use a Tex (or Latex) style text input for their solutions. Ideally, it should be WSWG style via hand writing as figures and graphs can also be used in the input.
Pace Control module: this module controls the pace of the assistance to the problem solving by the student. It passes the understood any answer step from the student to the tracking module. It starts to engage the student when it receives a guidance instruction from the guidance module and take into the consideration of the timing factor. That is, if it sees that the student is making a mistake at the current step, it may not provide a feedback immediately to correct the path towards the correct answer. Instead, it may delay a couple of steps in the hope that the student realizes that s/he made a mistake. It may also challenge the student even if the student makes a correct step based on the instruction from the guidance module. It is similar to a dialogue manager with various dialogue strategies, such as guidance timing strategies, clarification strategies, disambiguation strategies. It manages dialogue context and also decides what to say based on the context.
Presentation module: this module is responsible for how to interact with the student given all the information at the moment. It is initiated primarily by the Pace Control module. It formulates the content to the user according to specification from the pace control module.
Illustration Module: this module illustrates where the student is in the knowledge and competency space as reflected in the SU graph. It is initiated by the student if s/he wants to know her or his understanding of the subject. Similarly, it can also be started by any authorized person, such as a teacher to learn the status of the student and how the teacher may get involved in helping the student to improve further. It may use intuitive examples to show certain concepts and how the concepts evolve, and let the student to interact, including slowing down, speeding up, and skipping steps. These intuitive examples are attached to the concepts from the knowledge base of Subject Understanding, and are collected during its construction. They may also be collected through the offline domain knowledge and competence converter module, or from the 3^{rd} party assistance subsystem.

The Pace Control module is a key module which makes use of the four knowledge graphs described above in 2.1.1 and 2.1.2 to keep the students moving towards the correct solutions of a given problem.

### 2.2.3 The Offline Domain Knowledge and Competence Converter Module

This module converts a problem into the problem solving (PS) graph. It is primarily used in the initial time when a new problem in the subject area is given. This module includes the following three submodules.
Understanding of the original problem: it will cover word problem understanding and problems with pictures and graphs. It intends to convert the problem description into the initial node of the PS graph as well as a set of links to next level nodes that represent a correct understanding of the problem with the concepts in the subject. This part may make use of common sense knowledge in converting the problem description into the relevant concepts in the subject. It will also derive the goal or target of the problem.
Model Builder: it intends to establish or derive mathematical relationship among the concepts from the problem based on knowledge bases. This will include both the starting nodes with all the associated concepts and their mathematical relationship, as well as the target node with relevant concepts and intended findings as specified in the problem. Justification, i.e., the knowledge used to derive the relationship, is automatically augmented.
Equation Solving or Logical Reasoning: This involves a step-by-step solution finding from the initial node to one or more target nodes. Each reasoning step needs to have a justification from the knowledge bases. Justification from other sources need to be performed by authorized people, such as a qualified teacher or trainer.

In the beginning, the PS graph for a problem can be provided by the teacher or a trainer. For a specific problem, the teacher or trainer may indicate whether it is intuitive enough as an example to illustrate to any student. At later stages when many students provide correct solutions for a specific problem to the system, this module can then be fully automated. With the system described above, a procedure of automatic building of the PS graph for a particular problem can be done by aligning the solutions from the students, and augmenting relevant justification for each step. The justification can be supplied by problem and solution pairs, or derived via knowledge bases. A reinforcement learning algorithm can be deployed here so that the qualified teacher or trainer may only provide partial answers or hints to the system without the need to include detailed step-by-step solution paths. Examples of such hints from the teacher include a confirmation or disconfirmation of a specific step the student is making, a suggestion for a particular step at a certain point/node in PS graph.

This algorithm can also be used during the online assistance phase so to automate partially the assistance when a student gets stuck with a problem but a teacher only has a fragment of the time available or the teacher has to help multiple students at the same time. In this case, the algorithm serves as the teaching assistant to work with the students by providing hints or suggestions it acquired. See the description of the student problem support module and augment missing knowledge module of the 3^{rd} party assistance subsystem in 2.2.4.

2.2.4 The 3^{rd} party Assistance Subsystem

The subsystem is used to involve any qualified 3^{rd} party contributors to help the student in getting back to the right path towards the correct solution when the student went to a wrong path. It provides a real time or near real time assistance to the students. This subsystem includes the following modules.
Student Status Review Module: the module provides an authorized person to look at the student model in an intuitive way so that the authorized person can quickly understand the current status of the student. It allows any authorized person to access primarily the student model based on the authorization level given to the person. The status review will include the information such as the concepts learned, the concepts with difficulties, and the progress over past periods, etc. Its overlaps most of the functionality of Illustration Module for the student, and the additional features include authentication, authorization management, and teaching guidance.
Student Problem Support Module: the goal of this module is to provide suggestions about the next steps for the student to solve a problem at hand, request and support will be recorded in student model. This module provides an interface for any qualified teacher or trainer so that suggestions can be given to a student for him or her to move forward when he or she encountered hurdles during the problem solving. As the steps the student takes so far is recorded in SPSP graph, the 3^{rd} party teacher may suggest the next move based on the path the student has created in the SPSP graph, and link it to the PS graph. This can also be used to provide alternative solutions when requested by the student when a student already created a correct solution path in the SPSP graph. This module can access all internal info of the core assistance subsystem and the engagement subsystem so that the teacher can act on the status of the problem solving process accordingly. If it is detected that the student makes a mistake in understanding the problem as reflected in the SPSP graph, or has trouble moving forward when he or she takes too much time, the teacher can step in providing hints or other support. In addition, if the understanding module in the engagement subsystem raises a flag, the teacher can intervene and verify and correct any possible mistakes the understanding module makes.
Augment Missing Knowledge Module: this module is to enrich knowledge graph and competence graph only by qualified people. Anyone may suggest any missing knowledge if he or she passes a validation process so that only the ones that have gone through the process will be able to augment into the knowledge bases.

For subject related knowledge bases, this assistance subsystem enriches their content by collecting and augmenting validated solution paths or path segments. The reinforcement learning algorithm used in the offline knowledge converter can also be used here for the second and third modules above.

For student related knowledge bases, it accumulates relevant statistics indicating the deficiency and progress via the problem solving. Subsequently, the student model constructor builds and updates the SM with the collected statistics.

2. The Flow of how eGPS Work

The whole process in a subject learning typically includes teaching stage, practice stage, and testing stage. This section will provide a description of each stage.

### Teaching Stage

A typical teaching process would include
Concept introduction, and why
Example demonstration to show how the introduced concepts are applied, and why

### Practice Stage

During the practice stage, the students will often
review the concepts taught
take a number of problems and try to solve them

### Testing Stage

In a typical testing, one is to measure the understanding level of a student by asking the student to:
Explain certain concepts with examples using the right set of concepts and reasoning (interview)
Ability to solve a set of problems with certain correct scores (problem solving)

In all the three stages, one may see that the core is to acquire the concepts and be able to solve related problems. In addition, how well the students command the subject is related to the assessment obtained from many times of problem solving. Therefore, our system has a strong focus on the part of problem solving. An essential part of the problem solving involves these following aspects.

### Problem Solving

Extract entities and relationship from each sentence in the problem description
Map the entities and relationships to the concepts and relations in the field
Derive additional relationships leading to the solution

At each step above, the student may miss out some concepts or derive wrong concepts or relationships. At a certain point, the missing concepts or wrong concepts will prevent the student to go to the next state in the problem solving space. The missing concepts or the mis-derived concepts are marked.

Therefore, eGPS concerns with the following two primary functionalities:
the assistance to the problem solving by the student with the concepts in the subject domain
assessment of the concept acquisition level of a student via how well various problems are solved
   eGPS will provide a hint to lead the student to find the missing concepts/relationships or mis-derived concepts. Such hints may be given a few steps later when the student cannot move further or reached a wrong answer. The SP graph described above serves the purpose of tracking the steps the student makes, and providing references to the correct paths. SPSP graph is used as a reference to assess various understanding levels eGPS provides both automated assistance and semi-automated assistance. During the assistance, various hints are given, such as
Ask for clarification why certain steps are taken
Ask for what else can be derived
Ask for taking a step back and checking every derivation

Though the invention has been described with respect to specific preferred and alternative embodiments, many additional variations and modifications will become apparent to those skilled in the art upon reading the present application. Thus, it is the intention that the appended claims be interpreted as broadly as possible in view of the prior art to include all such variations and modifications.

I claim:

1. A student learning guidance platform comprising:
a functional module for understanding a problem and formulating solutions for the given problem thus formulating and providing possible paths from the given problem to the solutions.

2. The student learning guidance platform of claim 1 further comprising:
a functional module for monitoring how a student solves the problem when the student processes from a first state to a succeeding state in a problem space.

3. The student learning guidance platform of claim 1 further comprising:
a functional module for figuring out whether there is a gap between the student and a required and finding a reason why.

4. The student learning guidance platform of claim 1 further comprising:
a functional module for providing assistance where necessary and further providing a process for a competent teacher to participate assistance when necessary.

5. The student learning guidance platform of claim 1 further comprising:
a functional module for building a student model and recommending necessary steps for the student to improve.
